(19) United States
(12) Patent Application Publication
(10) Pub. No.: US 2026/0032406 A1
(43) Pub. Date: Jan. 29, 2026

(54) SCALING METHOD FOR FIRA UL-TDOA AND TWR UWB RANGING

(71) Applicant: Cisco Technology, Inc., San Jose, CA (US)

(72) Inventors: Jerome Henry, Pittsboro, NC (US); Ardalan Alizadeh, Milpitas, CA (US); Peiman Amini, Fremont, CA (US)

(21) Appl. No.: 19/192,888

(22) Filed: Apr. 29, 2025

Related U.S. Application Data
(60) Provisional application No. 63/675,538, filed on Jul. 25, 2024.

(51) Int. Cl. H04W 4/02; H04W 60/04; H04W 84/18

(52) U.S. Cl. CPC H04W 4/023; H04W 60/04; H04W 84/18

(57) ABSTRACT

A computer-implemented method includes receiving, at an access point (AP) in an ultra-wide band (UWB) network from a tag, a registration request; in response to receiving the registration request, transmitting, by the AP to the tag, a registration response to complete a pairing between the tag and the AP, the registration response including an indication of support for ranging services including Two-Way Ranging (TWR) and Uplink Time Difference of Arrival (UL-TDoA); upon completion of the pairing, receiving, at the AP from the tag, a request message for obtaining a set of parameters for one of the ranging services, the request message including an identifier of a UWB component stored on the tag and a periodicity for the one of the ranging services; and sending, by the AP to the tag, a response message including the set of parameters that includes a proposed periodicity for the one of the ranging services.

### CROSS-REFERENCE TO RELATED APPLICATION

This application claims the benefit of U.S. Provisional Patent Application No. 63/675,538 filed Jul. 25, 2024, which is incorporated by reference herein in its entirety.

### TECHNICAL FIELD

The present disclosure relates to wireless communication, and in particular to an Ultra-Wide Band (UWB) wireless network operating based on Fine Ranging (FiRa) consortium standards that accommodate near collision free coexistence of Uplink Time Difference of Arrival (UL-TDoA) and Two-Way Ranging (TWR) methods.

### BACKGROUND

Ultra-Wide Band (UWB) is a wireless technology that enables accurate indoor positioning and location-based services, up to 10 cm precise, even in challenging indoor environments which makes it ideally suited to enable real-time measurement of location, distance, and direction, while also supporting two-way communication.

IEEE 802.15.4 standard for wireless communication defines the operations of UWB. One of the widely adopted UWB-based standard is offered by FiRa consortium. FiRa Consortium is an industry alliance focused on promoting the adoption and interoperability of UWB technologies for secure, high-precision location-based services. FiRa's primary goal is to ensure seamless UWB integration across various consumer and enterprise applications. FiRa is consumer-driven, focusing on secure, short-range communication for devices like smartphones, smart access, and IoT applications. FiRa signaling procedures is more opportunistic in nature and hence more secure while other UWB-based standards such as Omlox are more deterministic.

The FiRa consortium allows TWR and UL-TDoA methods for locating devices. These methods locate devices using different procedures, each with their own respective advantages and disadvantages.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment operating based on FiRa standards, according to some aspects of the present disclosure.

FIG. 2 illustrates an example of multiple UL-TDoA frames transmission according to an embodiment of the present technology.

FIG. 3 illustrates a flow diagram according to an embodiment of the present technology.

FIG. 4 shows an example of a system for implementing certain aspects of the present technology.

### DETAILED DESCRIPTION OF EXAMPLE EMBODIMENTS

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It should be noted that throughout the present disclosure, references being made to FiRa are not meant to be limited to the specific FiRa consortium per se, but simply as an exemplary UWB specifications/standards. The present disclosure encompasses any future organizations that provide UWB specifications directed to industrial environment and applications, consumer-drive, etc. (an example of which is provided through FiRa consortium).

### Overview

Aspects of the present disclosure are directed to UWB-based deployments operating based on FiRa consortium standards, allowing for near collision free co-existence of UL-TDoA and TWR methods within the same cluster (deployment).

In one aspect, a computer-implemented method includes receiving, at an access point (AP) in an ultra-wide band (UWB) network from a tag, a registration request; in response to receiving the registration request, transmitting, by the AP to the tag, a registration response to complete a pairing between the tag and the AP, the registration response including an indication of support for ranging services including Two-Way Ranging (TWR) and Uplink Time Difference of Arrival (UL-TDoA); upon completion of the pairing, receiving, at the AP from the tag, a request message for obtaining a set of parameters for one of the ranging services, the request message including an identifier of a UWB component stored on the tag and a periodicity for the one of the ranging services; and sending, by the AP to the tag, a response message including the set of parameters, wherein the set of parameters includes a proposed periodicity for the one of the ranging services.

In another aspect, the one of the ranging services is the UL-TDoA and the set of parameters further includes a proposed slot that is specific to the tag.

In another aspect, the proposed slot specific to the tag is identified using a time reference of the proposed slot based on an end of a synchronization uplink time measurement (UTM).

In another aspect, the proposed slot specific to the tag is assigned to the tag independent of a media access control (MAC) address or an Uplink Time Difference of Arrival (UL-TDoA) device identifier (ID) of a particular anchor device with which the UL-TDoA is performed.

In another aspect, the computer-implemented method further includes determining, by the AP, a coverage area of the tag; and in response to determining that the coverage area of the tag is limited to a particular cluster, sending, by the AP to the tag, a media access controller (MAC) address or an Uplink Time Difference of Arrival (UL-TDoA) device identifier (ID) of a particular anchor device using out-of-band (OOB) signaling procedure.

In another aspect, the response message further includes instructions for the tag to tune to a UWB channel of the AP and report to the AP a list including at least one of: (i) one or more anchors detected by the tag, and (ii) one or more anchors not detected by the tag.

In another aspect, the one of the ranging services is the TWR, and the response message includes a list of one or more anchors for the tag to range with, and an associated validity time.

In one aspect, an access point (AP) in an ultra-wide band (UWB) network includes at least one memory configured to store computer-readable instructions and at least one processor communicatively coupled with the at least one memory. The at least one processor is configured to execute the computer-readable instructions to: receive, from a tag, a registration request; in response to receiving the registration request, transmit, to the tag, a registration response to complete a pairing between the tag and the AP, the registration response including an indication of support for ranging services including Two-Way Ranging (TWR) and Uplink Time Difference of Arrival (UL-TDoA; upon completion of the pairing, receive, from the tag, a request message for obtaining a set of parameters for one of the ranging services, the request message including an identifier of a UWB component stored on the tag and a periodicity for the one of the ranging services; and send, to the tag, a response message including the set of parameters, wherein the set of parameters includes a proposed periodicity for the one of the ranging services.

In one aspect, a non-transitory computer-readable media includes computer-readable instructions stored thereon, which, when executed by at least one processor of an access point (AP) in an ultra-wide band (UWB) network, cause the AP to: receive, from a tag, a registration request; in response to receiving the registration request, transmit, to the tag, a registration response to complete a pairing between the tag and the AP, the registration response including an indication of support for ranging services including Two-Way Ranging (TWR) and Uplink Time Difference of Arrival (UL-TDoA; upon completion of the pairing, receive, from the tag, a request message for obtaining a set of parameters for one of the ranging services, the request message including an identifier of a UWB component stored on the tag and a periodicity for the one of the ranging services; and send, to the tag, a response message including the set of parameters, wherein the set of parameters includes a proposed periodicity for the one of the ranging services.

### EXAMPLE EMBODIMENTS

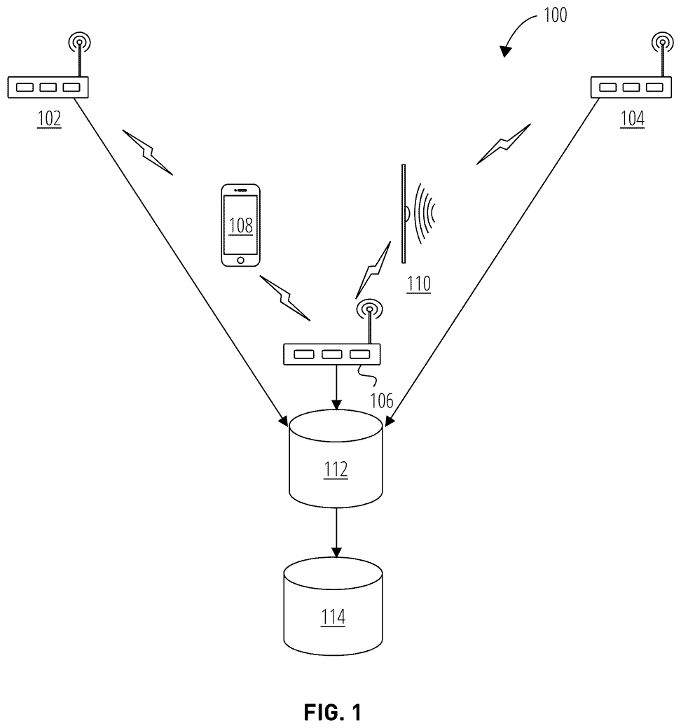

FIG. 1 illustrates an example environment operating based on FiRa standards, according to some aspects of the present disclosure.

In one example, environment 100 (which may also be referred to as an ecosystem or architecture) includes a plurality of UWB anchors such as anchor 102, anchor 104, and anchor 106, a plurality of tags such as tag 108 and tag 110, a positioning server such as server 112, and an application layer server such as application layer server 114. It should be noted that environment 100 may include any other known or to be developed component such as additional servers, communication components, etc. Furthermore, the number of various components such as anchors and tags are not limited to that shown in FIG. 1 and may be more or less.

Each one of anchor 102, anchor 104, and anchor 106 may be a fixed device capable of emitting and receiving (transmitting and receiving) UWB signals. In one example, such UWB signals may be utilized to determine a distance between a given anchor and a given tag as will be described in more detail below. Each of anchor 102, anchor 104, and anchor 106 may be an access point (AP), a UWB base station, and/or any other device capable of transmitting and receiving UWB signals and communicating with co-located and/or cloud-based servers such as server 112 and application layer server 114.

A tag may be any device that includes a UWB transceiver capable of communicating with an anchor. In non-limiting example of FIG. 1, tag 108 is a mobile device and tag 110 may be any known or to be developed UWB tag that may be wearable and capable of tracking assets, people, vehicles and equipment in various industrial and retail settings, etc. A tag may be referred to as a client device, a device, an asset, etc., throughout the present disclosure.

Server 112 can be referred to as a positioning server. Server 112 can be any on-premise and/or cloud-based server that is capable of communicating with anchor 102, anchor 104, and/or anchor 106. For example, server 112 can receive raw data from anchor 102, anchor 104, and/or anchor 106 and process the data to determine location of tag 108 and/or tag 110. As will be described below, server 112 may also function as a central synchronizer, a central orchestrator, or a central reference generator to coordinate ranging blocks for systems operating based on FiRa consortium standards (FiRa-based deployments).

Server 112 may be implemented using any known or to be developed Real-Time Location Service (RTLS) server, a UWB server, any known or to be developed public, provider, or hybrid cloud server, etc.

Application layer server 114 may be a server executing software application to provide real-time location data to end users and applications. Such software application may be any known or to be developed application including, but not limited to, commercially available asset tracking systems, indoor navigation applications, etc.

In order to determine a location of a tag, each anchor (e.g., anchor 102) may receive a signal transmission (e.g., a beacon or a pulse) from a tag such as tag 108. Using Time Difference of Arrival (TDoA) or Two-Way Ranging (TWR), an anchor can determine a distance between that anchor and any tag with which the anchor communicates. The TDoA can be an Up Link TDoA (UL-TDoA) or a Down Link TDoA (DL-TDoA).

Determining a distance between an anchor and a tag is made possible using a ranging block. Each anchor (e.g., anchor 102, anchor 104, and anchor 106) and each tag (e.g., tag 108 and tag 110) has a ranging block. A ranging block can handle Time of Flight (ToF) or TDoA calculations for localization and ultimately location determination.

For example, using a ranging block, an anchor or a tag can send and receive UWB pulses and record timestamps associated with each. By measuring time delay between transmitted and received signals using techniques such as TWR, UL-TDoA, and/or DL-TDoA, a distance between the anchor and the tag can be determined. TWR is a technique whereby round-trip time between a tag and an anchor is measured using transmitted and received pulses. UL-TDoA and DL-TDoA are techniques whereby a difference in arrival time at multiple anchors is used to measure a distance between each anchor and a tag.

In order to accurately determine distances between anchors and tags, ranging blocks of anchors and/or tags are synchronized. This synchronization can be achieved via various techniques including, but not limited to, a shared clock signal by anchors, periodic UWB broadcast messages (can be broadcasted by server 112 or a designated master anchor (e.g., one of anchor 102, anchor 104, and anchor 106), etc.

A ranging block may include several physical components including, but not limited to, a UWB transceiver, timing and clock synchronization unit, a signal processing unit, a data interface module, and a power management component. Specifications of a ranging block is defined by IEEE 802.15.4z specifications.

A ranging block may have a duration that refers to a time taken to complete a full ranging transaction between an anchor and a tag. The duration may be set according to the underlying ranging method used (e.g., TWR v. TDoA) and/or the required accuracy of location determination of assets (e.g., in a hospital v. a warehouse). For example, a duration of a ranging block may be set to 1 second. Each ranging block may include a plurality of ranging rounds. For instance, a ranging block can include 8 ranging rounds (4 active and 4 passive rounds), as will be further described below.

A ranging round is a complete cycle of message exchanges between a UWB tag and one or more UWB anchors to determine the distance (range) therebetween. Each ranging round consists of transmitting and receiving UWB pulses, recording timestamps, and performing distance calculations based on ToF and TDoA measurements.

Using distances determined by anchors and angle data from the anchors, server 112 can determine an accurate position of a given tag, which can be forwarded to application layer server 114 to be displayed in real-time on a terminal for asset tracking, navigation, and/or any other relevant application.

According to TWR and UL-TDoA) methods, a device can range with one or more anchors. In UL-TDoA, time is divided into blocks, with each block including several time units. Each block may begin with a synchronization message from an Uplink Time (UT) Synchronization anchor, followed by a silent time where UT-tags can send messages (e.g., blinks). To avoid repeating collisions, a UT-tag may send a blink message with a random TX offset time inside the defined UL-TDoA random window. However, collisions still occur because of a large number of UT-tags and multiple clusters of anchors each sending an independent sync message. Further, the known method of avoiding repeated collisions does not provide a scalable solution.

Additionally, while FiRa also allows TWR exchanges, where any side (anchor or tag) can start an exchange, there is a high risk of collision since there is no listen-before-talk mechanism or carrier-sense multiple access (CSMA) mechanism developed for UWB FiRa systems.

Aspects of the present disclosure address the above-described deficiencies by providing mechanisms for near collision free (minimized probability of collisions) co-existence of UL-TDoA and TWR methods in the same cluster/deployment.

As will be described in more detail below, the present disclosure augments existing FiRa specifications to allow for data exchange between a tag and an anchor within a UWB network.

The presently disclosed embodiments limit the ability for tags to start a TWR exchange, or blink without registration and authorization from the infrastructure. This method is compatible with FiRa legacy methods, because in both cases the tag needs to obtain the details of the UWB channel and implemented features using out-of-band (OOB) signaling procedures. Thus, upon approaching a region where UWB is deployed, the tag uses an OOB radio (e.g., Bluetooth® low energy (BLE) or Wi-Fi) to discover UWB parameters.

In the BLE case, some existing configurations allow a BLE radio associated with the infrastructure to signal that UWB is available with a specific message. The tag can then pair with the BLE radio to obtain specific information about the UWB network (e.g., channel etc.). In the Wi-Fi case, the access point (AP) can express, in probe responses and beacons, the presence of UWB and/or some key parameters. In the first case, using a Wi-Fi radio of the tag, the tag can query the AP to obtain the complete set of parameters. However, some of the currently known systems only allow these UWB parameters to be shared with a device that is associated with the network.

The presently disclosed technology (herein called the AP, using WiFi as an example, but with BLE using the same principles) may indicate that TWR (or UL-TDoA or both) is supported, but only upon registration. The tag requesting such services (after pairing in the BLE case, and with or without association depending on the requirements above in the WiFi case) can send a request to the AP for the service (for example, using Access Network Query Protocol (ANQP)). The request may include an identifier (e.g., media access control (MAC) address) of the UWB entity on the tag, along with a periodicity for the service. The AP response to the tag's request includes a proposal for periodicity. In the case of UL-TDoA, the AP response also proposes a slot (e.g., 12 milliseconds (ms) after the end of the synchronization (sync) uplink time measurement (UTM) in each odd round).

Because clock drifts may occur and limit the precision of the tag, the AP generally accounts for this risk when allocating the slots to different tags (e.g., by not allocating consecutive slots to two nearby tags). The time reference of the allocated slot is based on the end of the sync UTM. In the case of multiple clusters of anchors such as, if there are more than one UT synchronization anchor, there are two likely scenarios for consideration. The first scenario is when the coverage area of tag is limited to certain area or cluster, and the second scenario is where the time office is assigned to a tag independent of the device ID.

In the first scenario, the MAC address (also referenced herein as a UL-TDoA Device ID in FiRa) of the specific sync anchor to be used as reference is sent to the tag via GOB signaling procedures (or using an OOB radio). In the second scenario, where the time offset is assigned to the tag independent of the device ID, the UT tag considers the assigned time offset to send its blink based on any received sync. In the second scenario, the time alignment between the UT sync anchors is used that is determined in-band via sync UTMs, or from any time sync mechanism in the infrastructure.

The method for a FiRa deployment, according to examples of the present disclosure, accommodates both UL-TDoA and TWR methods in the same clusters (and same deployment). Both UL-TDoA and TWR methods can be supported by the devices and thereby provide improvement to some devices that only support one of these methods. Additionally, the specific methods described herein avoids collision of the TWR method with the UL-TDoA method. In some cases, a tag may attempt UL-TDoA first, and the TWR method later if required. The tag's attempt using the UL-TDoA method may be detected by one or a few anchors, which is an insufficient number for proper hyperbolic TDOA localization. The tag then attempts using the TWR method.

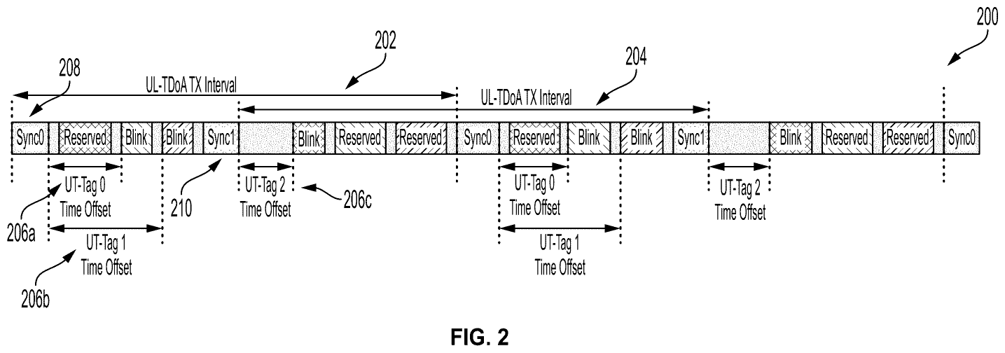

FIG. 2 illustrates an example of multiple UL-TDoA frames transmission 200. The UL-TDoA frames transmission 200 shown in FIG. 2 shows two UL-TDoA frames 202 and 204 being transmitted. Each of the two UL-TDoA frames 202 and 204 is transmitted by two different UT-anchors (shown in FIG. 1). Each of the two different UT-anchors has a respective cluster; accordingly, there are two different clusters. Each UT-anchor is transmitting sync UTMs. By way of an example, the TX Intervals of both clusters may be same, and each interval may be divided equally between two clusters. In FIG. 2, three tags UT-Tag 0 206a, UT-Tag 1 206b, and UT-Tag 2 206c are shown. UT-Tag 0 206a and UT-Tag 1 206b use sync-0 208 corresponding to cluster 0 as the reference, and UT-Tag 2 206c uses sync-1 210 from cluster 1 as the reference.

The replicated time slots are reserved since the infrastructure does not know which references are selected by the tags. To better utilize the unused reserved times, more than one tag is assigned per time slot. In this case, the time window size is considered larger with random offset to minimize the probability of collision in the same time slot. Alternatively, or additionally, the tag may report the device ID of sync (sync-0 or sync-1) as reference in the OOB reports as described below.

In one embodiment, the AP instructs the tag to tune its receiver (Rx) radio to the UWB channel. The tag then reports the anchors that were detected. In the case of TWR, the AP may also instruct the tag to report which anchors in the list provided by the AP were detected, which anchors in the list provided by the AP were not detected and also report a list of other anchors that are not mentioned by the AP but should have been detected by the tag. Based upon the report from the tag, the AP then provides a new proposal.

As described herein, the tag then tunes to the UWB channel, and the tag then uses the round number indication at the beginning of each round to identify the rounds of interest and communicate in its allocated slot. In the case of TWR, the AP may also indicate a list of one or more anchors identified using their respective MAC addresses that the tag may attempt to range with. The AP may also specify a validity limit or the time beyond which the tag should query an AP of the ESS again for a new schedule. By way of an example, the request to tag may be based on time scheduled or contention-based TWR. For the case of a time scheduled request to the tag, the AP plays the controller role while the tag or AP is an initiator. For the case of contention-based TWR, the tag is not an initiator to minimize the probability of collision. The infrastructure considers a portion of the time in between UL-TDoA TX intervals for the TWR scheduling.

As described herein, in one embodiment, the tag can perform or act as a controller to range to many APs in a single session. Alternatively, in another embodiment, the AP can perform or act as a controller to range many tags.

In some examples, in order to reduce the probability of collision and to scale the network, transmission power of UT-Tags may be controlled based upon the received signal strength indicator (RSSI) of blink. Each UT anchor provides the infrastructure-based, or real time location system (RTLS) based, information to predict the impact of the TWR sessions in the neighboring clusters or neighboring APs. Accordingly, in some examples, the optimal transmit power is also requested by an AP via OOB signaling procedures (or using an OOB radio) in accordance with the blink TX power as reference point. For instance, when the RSSI in the undesired AP is −94 dBm while the desired AP is −75 dBm, AP requests a tag to reduce the Tx power by, for example, 10 dBm.

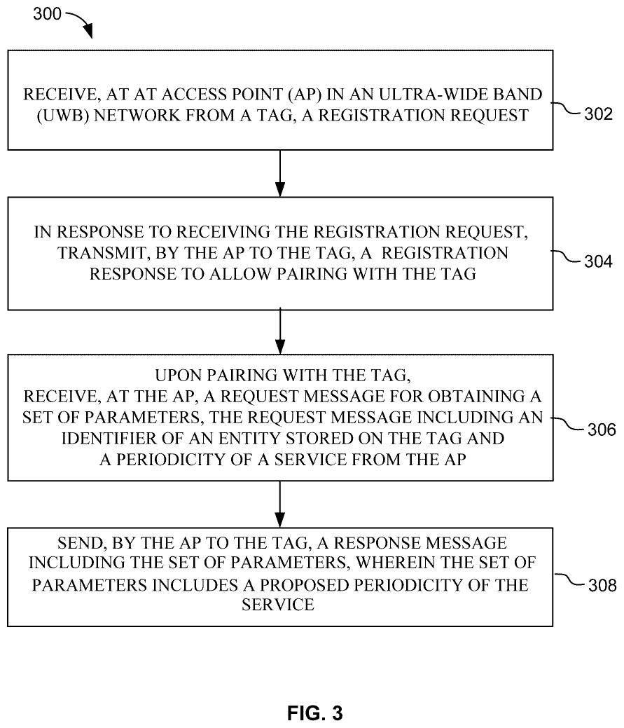

FIG. 3 illustrates an example routine 300 for exchanging data between a device and an anchor or access point within a UWB network. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes, at step 302, receiving at an AP (e.g., AP 102 or AP 104 shown in FIG. 1) in an ultra-wide band (UWB) network a registration request from a device or a tag (e.g., tag 108 or tag 110 shown in FIG. 1). The device of the tag may be registered with the AP in the UWB network as a TWR tag or an UL-TDoA tag.

The method includes, at step 304, transmitting by the AP to the client device or the tag, a registration response. The registration response indicates to the client device or the tag whether the client device or the tag is allowed to pair with the AP or not. In other words, the registration response enables the client device or the tag to complete a pairing between the AP and the client device, or the AP and the tag. The registration response further includes an indication of support for ranging services, as described herein. The ranging services may include an UL-TDoA and/or TWR.

In the case, when the client device or the tag is allowed to pair with the AP, and upon completion of the pairing, the method includes, at step 306, receiving, at the AP, a request message for obtaining a set of parameters for one of the ranging services including the TWR and/or the UL-TDoA. The request message may include an identifier of an entity (or a UWB component) stored on the client device or the tag and a periodicity for one of the ranging services, as desired by the client device or the tag.

In response to the received request message at step 306, the method includes sending a response message, at step 308. The response message sent from the AP to the client device, or the tag, includes a proposed periodicity for the one of the ranging services.

Additionally, the response message sent from the AP to the client device, or the tag, may further include a proposed slot that is specific to the client device, or the tag when the ranging service requested by the client device or the tag is UL-TDoA. The proposed slot specific to the client device, or the tag, may be identified using a time reference of the proposed slot. The time reference of the proposed slot may be based on an end of a synchronization uplink time measurement (UTM). Alternatively, the response message sent from the AP to the client device, or the tag, may further include a list of one or more anchors for the client device or the tag to range with, and an associated validity time, when the ranging service requested by the client device or the tag is TWR.

Additionally, the response message may instruct the client device or the tag to tune to a UWB channel of the AP and report to the AP one or more anchors of a list detected by the client device or the tag, and one or more anchors of the list that are not detected by the client device or the tag. Additionally, or alternatively, the response message may also instruct the client device or the tag to report to the AP one or more anchors that are not included in the list but detected by the client device or the tag.

The AP may receive from the client device or the tag a blink at the proposed slot that is specific to the client device or the tag. Additionally, or alternatively, the proposed slot specific to the client device or the tag may be assigned independent of a media access control (MAC) address or an uplink time difference of arrival (TDoA) device identifier (ID) of a particular anchor device (or an AP) with which the UL-TDoA is performed. Further, the proposed slot (e.g., a first proposed slot) specific to one client device or tag may be different from another proposed slot specific (e.g., a second proposed slot) to another client device or tag. By way of an example, the first proposed slot and the second proposed slot may be consecutive slots or non-consecutive slots.

Additionally, in some examples, the AP may also determine a coverage area of the client device or tag. Upon determining that the coverage area of the client device or tag is limited to a particular cluster, the AP may send a MAC address or an UL-TDoA device identifier (ID) of a particular anchor device using out-of-band (OOB) signaling procedures (or using an OOB radio).

In some examples, the client device or the tag may perform as a controller to range to more than one AP, including the AP, in a single session. Each of the more than one AP may be identified by a respective MAC address of each AP. Alternatively, the AP may perform as a controller to range more than one client device or tag including the client device or the tag. In some examples, the AP may also instruct the client device or the tag to update transmission power of the client device or the tag by a specific transmission power change.

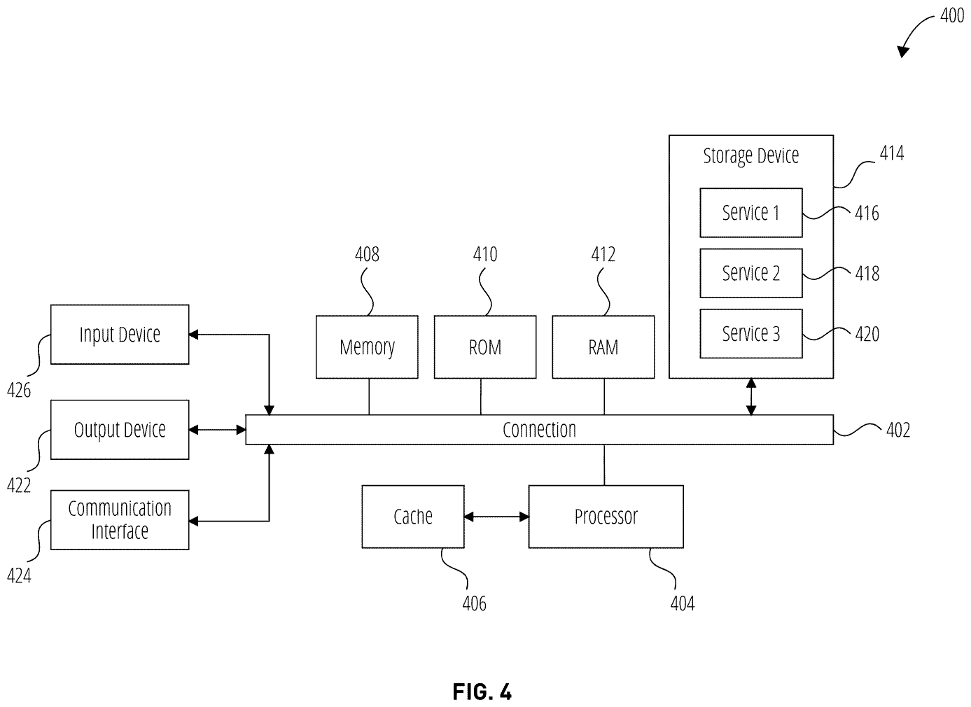

FIG. 4 shows an example of computing system 400, which can be for example any computing device making up the client device 108 or 110 or any component thereof, or an AP 102 or 104 or any component thereof, in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some examples, computing system 400 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 400 includes at least one processing unit (CPU or processor) 404 and connection 402 that couples various system components including system memory 408, such as read-only memory (ROM) 410 and random-access memory (RAM) 412 to processor 404. Computing system 400 can include a cache of high-speed memory 406 connected directly with, in close proximity to, or integrated as part of processor 404.

Processor 404 can include any general-purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some examples, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some examples, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
receiving, at an access point (AP) in an ultra-wide band (UWB) network from a tag, a registration request;
in response to receiving the registration request, transmitting, by the AP to the tag, a registration response to complete a pairing between the tag and the AP, the registration response including an indication of support for ranging services including Two-Way Ranging (TWR) and Uplink Time Difference of Arrival (UL-TDoA);
upon completion of the pairing, receiving, at the AP from the tag, a request message for obtaining a set of parameters for one of the ranging services, the request message including an identifier of a UWB component stored on the tag and a periodicity for the one of the ranging services; and
sending, by the AP to the tag, a response message including the set of parameters, wherein the set of parameters includes a proposed periodicity for the one of the ranging services.

2. The computer-implemented method of claim 1, wherein the one of the ranging services is the UL-TDoA and the set of parameters further includes a proposed slot that is specific to the tag.

3. The computer-implemented method of claim 2, wherein the proposed slot specific to the tag is identified using a time reference of the proposed slot based on an end of a synchronization uplink time measurement (UTM).

4. The computer-implemented method of claim 2, wherein the proposed slot specific to the tag is assigned to the tag independent of a media access control (MAC) address or an Uplink Time Difference of Arrival (UL-TDoA) device identifier (ID) of a particular anchor device with which the UL-TDoA is performed.

5. The computer-implemented method of claim 1, further comprising:
determining, by the AP, a coverage area of the tag; and
in response to determining that the coverage area of the tag is limited to a particular cluster, sending, by the AP to the tag, a media access controller (MAC) address or an Uplink Time Difference of Arrival (UL-TDoA) device identifier (ID) of a particular anchor device using an out-of-band (OOB) signaling procedure.

6. The computer-implemented method of claim 1, wherein the response message further includes instructions for the tag to tune to a UWB channel of the AP and report to the AP a list including at least one of: (i) one or more anchors detected by the tag, and (ii) one or more anchors not detected by the tag.

7. The computer-implemented method of claim 1, wherein the one of the ranging services is the TWR, and the response message includes a list of one or more anchors for the tag to range with, and an associated validity time.

8. An access point (AP) in an ultra-wide band (UWB) network, the AP comprising:
at least one memory configured to store computer-readable instructions; and
at least one processor communicatively coupled with the at least one memory, and configured to execute the computer-readable instructions to:
receive, from a tag, a registration request;
in response to receiving the registration request, transmit, to the tag, a registration response to complete a pairing between the tag and the AP, the registration response including an indication of support for ranging services including Two-Way Ranging (TWR) and Uplink Time Difference of Arrival (UL-TDoA);
upon completion of the pairing, receive, from the tag, a request message for obtaining a set of parameters for one of the ranging services, the request message including an identifier of a UWB component stored on the tag and a periodicity for the one of the ranging services; and
send, to the tag, a response message including the set of parameters, wherein the set of parameters includes a proposed periodicity for the one of the ranging services.

9. The AP of claim 8, wherein the set of parameters further includes a proposed slot that is specific to the tag.

10. The AP of claim 9, wherein the one of the ranging services is the UL-TDoA and the proposed slot specific to the tag is identified using a time reference of the proposed slot based on an end of a synchronization uplink time measurement (UTM).

11. The AP of claim 9, wherein the proposed slot specific to the tag is assigned to the tag independent of a media access control (MAC) address or an Uplink Time Difference of Arrival (UL-TDoA) device identifier (ID) of a particular anchor device with which the UL-TDoA is performed.

12. The AP of claim 8, wherein the at least one processor is further configured to execute the computer-readable instructions to:
determine a coverage area of the tag; and
in response to determining that the coverage area of the tag is limited to a particular cluster, send, to the tag, a media access controller (MAC) address or an Uplink Time Difference of Arrival (UL-TDoA) device identifier (ID) of a particular anchor device using an out-of-band (OOB) signaling procedure.

13. The AP of claim 8, wherein the response message further includes instructions for the tag to tune to a UWB channel of the AP and report to the AP a list including at least one of: (i) one or more anchors detected by the tag, and (ii) one or more anchors not detected by the tag.

14. The AP of claim 8, wherein the one of the ranging services is the TWR, and the response message includes a list of one or more anchors for the tag to range with, and an associated validity time.

15. A non-transitory computer-readable media comprising computer-readable instructions stored thereon, which, when executed by at least one processor of an access point (AP) in an ultra-wide band (UWB) network, cause the AP to:
receive, from a tag, a registration request;
in response to receiving the registration request, transmit, to the tag, a registration response to complete a pairing between the tag and the AP, the registration response including an indication of support for ranging services including Two-Way Ranging (TWR) and Uplink Time Difference of Arrival (UL-TDoA);
upon completion of the pairing, receive, from the tag, a request message for obtaining a set of parameters for one of the ranging services, the request message including an identifier of a UWB component of the tag and a periodicity for the one of the ranging services; and
send, to the tag, a response message including the set of parameters, wherein the set of parameters includes a proposed periodicity for the one of the ranging services.

16. The non-transitory computer-readable media of claim 15, wherein the one of the ranging services is the UL-TDoA and the set of parameters further includes a proposed slot that is specific to the tag.

17. The non-transitory computer-readable media of claim 16, wherein the proposed slot specific to the tag is identified using a time reference of the proposed slot based on an end of a synchronization uplink time measurement (UTM), and wherein the proposed slot specific to the tag is assigned to the tag independent of a media access control (MAC) address or an Uplink Time Difference of Arrival (UL-TDoA) device identifier (ID) of a particular anchor device with which the UL-TDoA is performed.

18. The non-transitory computer-readable media of claim 15, wherein the at least one processor is further configured to execute the computer-readable instructions to:
determine a coverage area of the tag; and
in response to determining that the coverage area of the tag is limited to a particular cluster, send, to the tag, a media access controller (MAC) address or an Uplink Time Difference of Arrival (UL-TDoA) device identifier (ID) of a particular anchor device using an out-of-band (OOB) signaling procedure.

19. The non-transitory computer-readable media of claim 15, wherein the response message further includes instructions for the tag to tune to a UWB channel of the AP and report to the AP a list including at least one of: (i) one or more anchors detected by the tag, and (ii) one or more anchors not detected by the tag.

20. The non-transitory computer-readable media of claim 15, wherein the one of the ranging services is the TWR, and the response message includes a list of one or more anchors for the tag to range with, and an associated validity time.
